(19) United States
(12) Patent Application Publication
(10) Pub. No.: US 2004/0131343 A1
(43) Pub. Date: Jul. 8, 2004

(54) Partitioning of spindle motor driver control and waveshape circutry between mixed signal and digital IC's

(76) Inventors: Robert E. Whyte JR., Dallas, TX (US); Frederick W. Trafton, Lewisville, TX (US); Liyong Chen, Plano, TX (US)

Correspondence Address: TEXAS INSTRUMENTS INCORPORATED, P O BOX 655474, M/S 3999, DALLAS, TX, 75265

(21) Appl. No.: 10/741,402

(22) Filed: Dec. 19, 2003

Related U.S. Application Data
(60) Provisional application No. 60/434,939, filed on Dec. 20, 2002.

(51) Int. Cl. H02P 5/165

(52) U.S. Cl. 388/809

(57) ABSTRACT

Disclosed are circuits and circuit architectures for partitioning between a hard disk drive assembly mixed signal spindle motor driver and additional associated digital circuitry.

### RELATED APPLICATION

This application claims priority based on Provisional Patent Application 60/434,939 (Attorney Docket Number TI-35730PS), which has been given a filing date of Dec. 20, 2002. This application and the aforementioned Provisional Patent Application have at least one common inventor and are assigned to the same entity.

### TECHNICAL FIELD

The invention relates to electronics and electronic circuits. More particularly, the invention relates to electronic circuits used to control and interface with a hard disk drive motor control and waveshaping circuitry.

### BACKGROUND OF THE INVENTION

Hard disk drive spindle motor control and waveshaping circuitry often uses digital circuits. Mixed signal processes now used for motor control circuitry, both analog and digital, are less economical to implement than strictly digital processes.

FIG. 1 is a schematic block diagram showing an example of a circuit representative of the prior art. Functional blocks specific to spindle driver functions are shown in a mixed signal device 10. Those skilled in the arts should understand that other functional blocks found in circuits known in the arts have been omitted for clarity. A spindle motor 12 is shown electrically connected to spindle motor drivers 14. Serial ports 16 are commonly used for input to the mixed signal device 16. Pursuant to signal requirements and references known in the arts, the operational requirements of the spindle motor 12 are controlled by the spindle motor drivers 14, which receive their instructions from digital signal processing circuitry 18 and waveform generators 20 on board the mixed signal device 10. Hard disk drive spindle control and waveshaping circuits are becoming increasingly digital-logic intensive in order to meet demanding operational requirements. Mixed signal circuitry is generally less efficient in terms of processing capabilities and costs, than digital circuitry.

New circuit architecture partitioning between a hard disk drive assembly mixed signal motor driver and additional associated digital circuitry would be useful and advantageous in the arts. Such partitioning would provide useful advantages including but not limited to increased efficiency in the use of digital circuitry and reduced costs.

### SUMMARY OF THE INVENTION

In carrying out the principles of the present invention, in accordance with preferred embodiments thereof, architecture and circuitry for performing spindle motor control and waveshaping functions without substantially increasing the pin count of the mixed signal device are described.

According to one aspect of the invention, spindle motor driver architecture is described in which the majority of the digital signal processing used for spindle motor driver control is performed in a digital ASIC external to a mixed signal driver device.

According to another aspect of the invention, a preferred embodiment of a circuit implementing the invention includes a mixed signal is coupled to a spindle motor. The mixed signal device has spindle driver functionality and is configured to accept digital signal processing output, such as waveform generation, from a digital ASIC having digital signal processing functionality. A serial port and a digital bi-directional communications port are used to connect the mixed signal device and the digital ASIC.

According to yet another aspect of the invention, a digital ASIC is used in a new spindle motor driver architecture wherein a digital ASIC is used to implement phase detector functionality.

According to still another aspect of the invention, the spindle motor driver architecture of the invention includes a digital ASIC wherein resides speed control functionality.

The invention provides technical advantages over the prior art including but not limited to improvements in efficiency and cost. These and other features, advantages, and benefits of the present invention can be understood upon careful consideration of the detailed description of representative embodiments of the invention in connection with the accompanying drawings.

### BRIEF DESCRIPTION OF THE DRAWINGS

The present invention will be more clearly understood from consideration of the following detailed description and drawings in which:

FIG. 1 is a schematic circuit diagram showing an example of a circuit of the prior art; and

FIG. 2 is a schematic circuit diagram illustrating an example of a preferred embodiment of the invention.

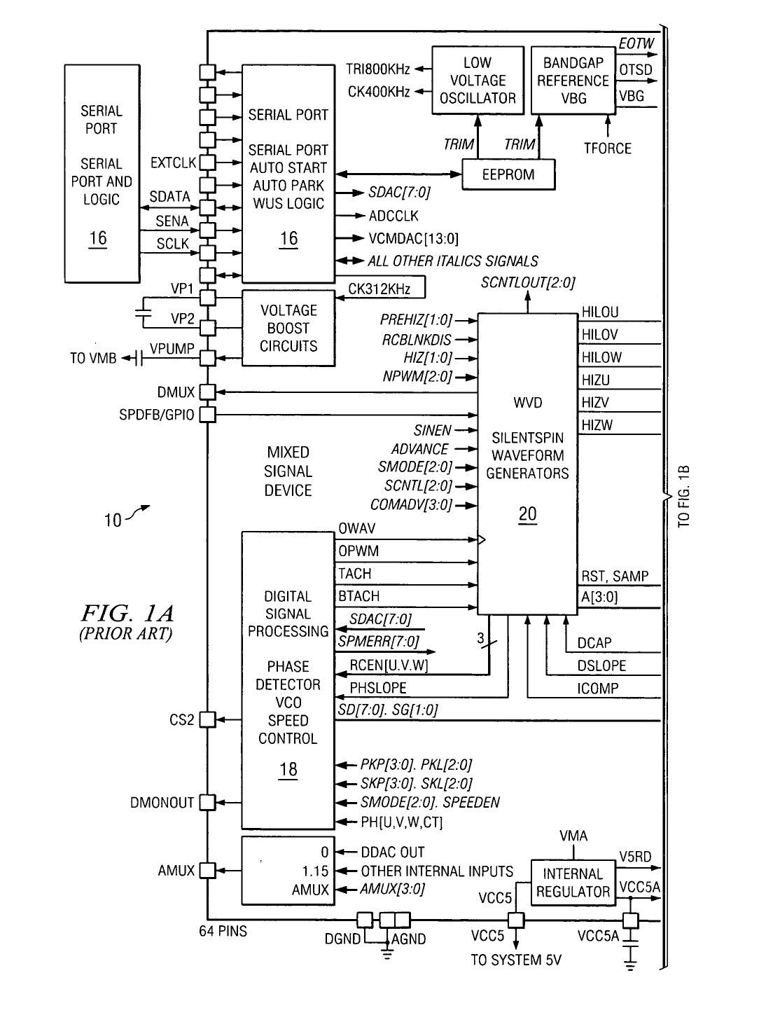

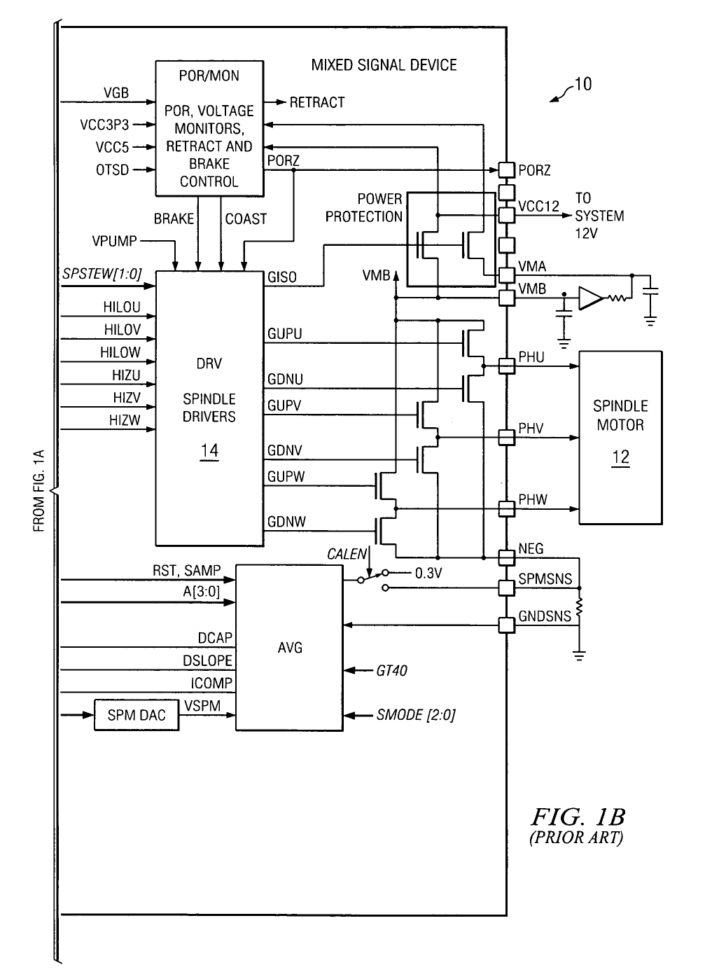

References in the detailed description correspond to the references in the figures unless otherwise noted. Descriptive and directional terms used in the written description such as first, second, left, right, top, bottom, and so forth refer to the drawings themselves as laid out on the paper and not to physical limitations of the invention unless specifically noted. The drawings are not to scale, and some features of embodiments shown and discussed are simplified or amplified for illustrating the principles, features, and advantages of the invention.

### DETAILED DESCRIPTION OF PREFERRED EMBODIMENTS

In general, the preferred embodiments of the invention provide new spindle motor driver control and waveshaping circuitry architecture. The inventions make use of partitioning between a mixed signal device for direct control of a spindle motor, and a digital ASIC device for digital processing tasks.

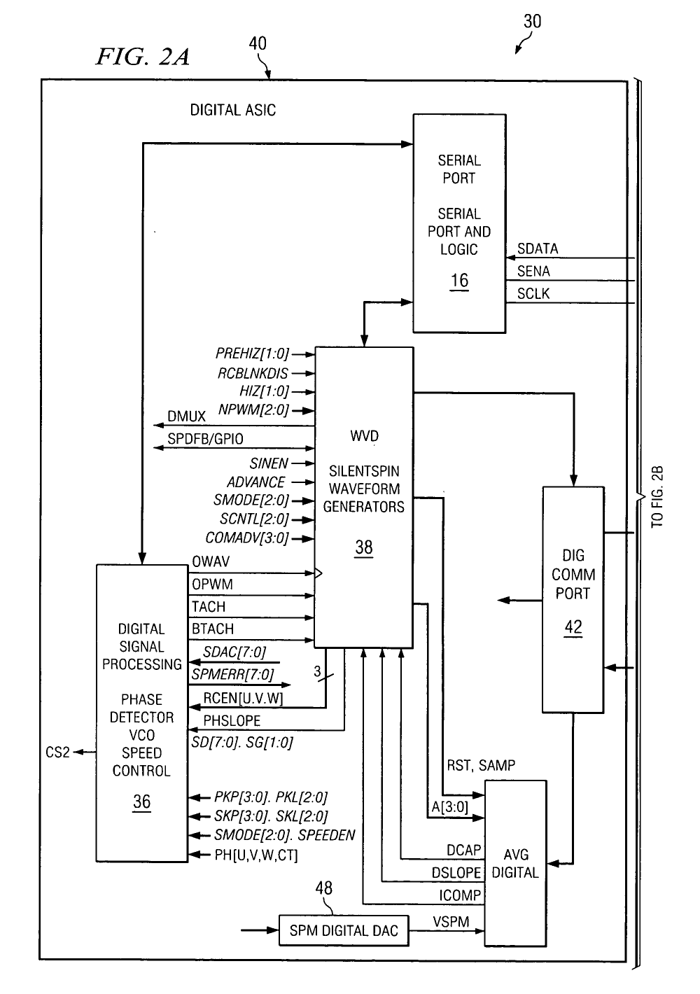

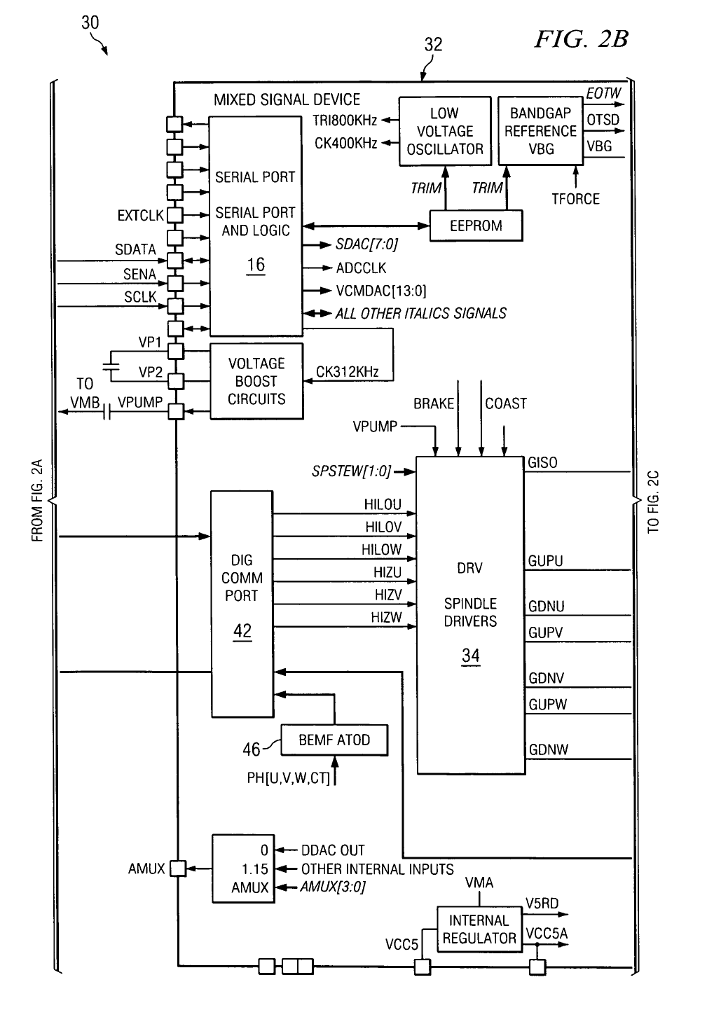

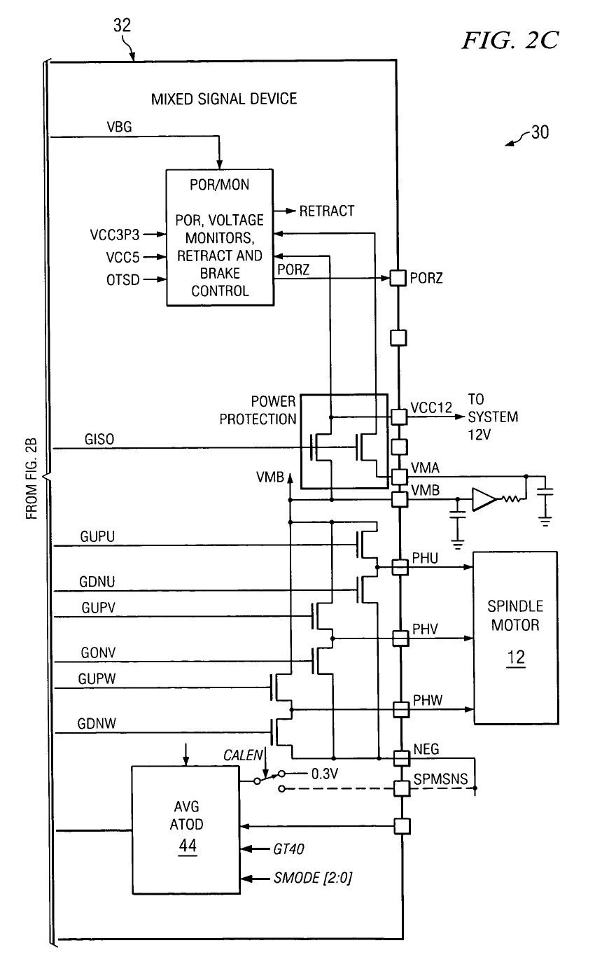

Referring primarily to FIG. 2, an example of circuitry and architecture 30 in a preferred embodiment implementing the inventions is shown. Functional blocks specific to spindle driver functions are shown, it should be understood that other functional blocks typically found in spindle motor circuits and systems but not essential to the driver control and waveshaping aspects of the inventions have been omitted for the purposes of illustration. A mixed signal device 32 is connected to a spindle motor 12 as known in hard disk drive systems. The spindle motor 12 is electrically connected to spindle motor drivers 34. The spindle motor drivers 34 are used for executing controls over the spindle motors 12 according to application requirements. The spindle motor drivers 34 receive instructions from digital signal processing circuitry 36 and waveform generators 38 external to the mixed signal device 32.

A digital ASIC device 40 is shown coupled to the mixed signal device 32. The digital ASIC device 40 contains a digital signal processing block 36 for performing phase detector, VCO, and speed control operations using digital logic. A waveform generator 38 is also implemented in the digital ASIC 40. A bi-directional digital communications port 42 is preferably included in both the mixed signal device 32 and the digital ASIC 40 in order to enable the exchange of control and status information between the respective devices 32, 40. It should be appreciated by skilled practitioners of the art, that the use of a digital ASIC 40 for implementing digital logic functions results in lower costs than providing the same functionality within a mixed signal device of the prior art, so long as pin counts are not substantially increased. It should also be noted that some additional features are required in order to implement the partitioned architecture of the invention. For example, portions of the serial port 16 blocks must be duplicated in the mixed signal device 32 and the digital ASIC device 40. Additionally, the “averaging” AVG block 44 of the mixed signal device 32 and Back EMF (BEMF) measurement block 46 include analog-to-digital converters (ADCs), and a corresponding digital-to-analog converter (DAC) 48 is included in the digital ASIC 40.

Thus, the invention includes new system architecture and circuitry for providing spindle motor control and waveshaping using partitioned mixed-signal and digital signal processing circuitry. While the invention has been described with reference to certain illustrative embodiments, the methods and apparatus described are not intended to be construed in a limiting sense. Artisans will appreciate that the circuits shown and described are examples only and that many components may be substituted with their logical equivalents without departing from the principles of invention. Various modifications and combinations of the illustrative embodiments as well as other advantages and embodiments of the invention will be apparent to persons skilled in the arts upon reference to the description and claims.

We claim:

1. A spindle motor driver architecture comprising:
a mixed signal device having a spindle driver functionality operably coupled to a spindle motor;
a digital ASIC having a digital signal processing functionality;
a serial port and a digital bi-directional communications port operably connecting the mixed signal device and the digital ASIC, whereby digital signal processing functions associated with waveshaping and other digital functions required by the hard disk drive may be performed by the digital ASIC device, and whereby spindle motor driver functions and other analog functions required by the hard disk drive may be performed by the mixed signal device.

2. The spindle motor driver architecture according to claim 1 wherein the digital ASIC further comprises phase detector functionality.

3. The spindle motor driver architecture according to claim 1 wherein the digital ASIC further comprises speed control functionality.

4. The spindle motor driver architecture according to claim 1 wherein the digital ASIC further comprises digitally controlled frequency synthesizer (DVCO) functionality.

5. A spindle motor driver circuit comprising:
a mixed signal device having a spindle driver block operably coupled to a spindle motor, whereby spindle motor driver functions and other analog functions required by the hard disk drive may be performed by the mixed signal device, the mixed signal device further comprising a serial port and a communications port;
a digital ASIC having a digital signal processing block and further comprising a serial port and a communications port operably coupled to the serial port and communications port of the mixed signal device, whereby digital signal processing functions associated with waveshaping and other digital functions required by the hard disk drive may be performed by the digital ASIC device.

6. The spindle motor driver architecture according to claim 5 wherein the digital ASIC further comprises phase detector functionality.

7. The spindle motor driver architecture according to claim 5 wherein the digital ASIC further comprises speed control functionality.

8. The spindle motor driver architecture according to claim 5 wherein the digital ASIC further comprises digitally controlled frequency synthesizer (DVCO) functionality.
